(19) United States
(12) Patent Application Publication
(10) Pub. No.: US 2005/0205215 A1
(43) Pub. Date: Sep. 22, 2005

(54) Apparatus for the evaporation of aqueous organic liquids and the production of powder pre-forms in flame hydrolysis processes

(75) Inventors: Robert Arthur Giddings, Slingerlands, NY (US); Raul Eduardo Ayala, Clifton Park, NY (US)

Correspondence Address: General Electric Company;CRD Patent Docket Rm 4A59, Bldg. K-1, P.O. Box 8, Schenectady, NY, 12301, US

(73) Assignee: General Electric Company

(21) Appl. No.: 10/801,250

(22) Filed: Mar. 17, 2004

(51) Int. Cl. B01D 1/14

(52) U.S. Cl. 159/47.1; 159/28.6; 159/44; 159/38; 159/16.1; 159/48.1; 159/DIG. 8

(57) ABSTRACT

An organic liquid evaporation system is disclosed. The organic liquid evaporation system comprises a housing having at least one inlet and at least one outlet. At least a first evaporator plate radially extending from a sidewall of the housing, and at least a second evaporator plate radially extending from a sidewall of the housing define a serpentine flow path within the housing. A heating source is in thermal communication with the first evaporator plate and the second evaporator plate, wherein the heating source provides heat to the first and second evaporator plates to evaporate organic liquid introduced within the inlet to produce a vapor through the outlet. A method for preparing powder pre-forms and oxide soot using the organic liquid evaporation system is also disclosed.

### BACKGROUND OF INVENTION

This invention relates to an evaporation device. More particularly, this invention relates to an evaporator to produce powder performs from aqueous, organic fluids.

Evaporators are widely used in catalysis, materials processing and in healthcare to produce finely dispersed particulates having a high surface area. One feature of these devices is a heating plate that heats a liquid precursor to a vapor. Vaporized particulates are collected on a substrate and compacted, and optionally heat-treated or sintered to yield a structured material possessing the desired properties.

Liquid precursor evaporation has been conventionally performed using a variety of devices, including but not limited to, tube-type vaporizers, pot-type vaporizers, single-plate slanted vaporizers, vertical falling film evaporators, droplet-generating hollow shafts that spray fluid droplets, packed column evaporators where fluid is vertically sprayed onto a porous packed column and channel type chamber evaporators where fluid flows along an inclined plane with heaters at the top and bottom walls of the inclined plane.

One problem associated with such conventional evaporator assemblies is a large pressure drop across the evaporator leading to discontinuous dispensing of precursor vapors. In tube-type vaporizers, the fluid boils inside a narrow tube and produces slugs of gases that cause significant fluctuations in pressure and an unsteady flow rate of vapor to the end of the tube. Such dispensing is disruptive to the steady flame operation in a flame hydrolysis process. In pot-type vaporizers, the fluid is fed into a vessel and replenished as liquid levels drops with time and evaporator usage. Due to an unsteady state operation, the addition of fluid as a batch or at a constant rate into the vessel does not immediately result in the production of a steady state vapor flow rate delivered by the evaporator. The result is poor control of precursor vapor delivery flow at the flame hydrolysis process. In single plate slanted vaporizers, the fluid is vaporized on a metal plate. Typically, the fluid dribbles across the plate as a narrow stream and in a random fashion such that a significant fraction of the heating surface is not covered by a liquid film resulting in very ineffective vaporization.

In summary, conventional methods of evaporating fluids and producing powder pre-forms use evaporator assemblies that do not enable steady and controlled dispensing of vapor at the flame hydrolysis system. Therefore, what is needed is an evaporator with a relatively low pressure drop across the fluid inlet and the vapor outlet. What is also needed is an assembly that provides an independence of fluid flow rate from the desired pressure at the vapor outlet. What is also needed is an evaporator with a high surface area for more efficient heat transfer.

### BRIEF SUMMARY OF THE INVENTION

The invention meets these and other needs by providing an organic liquid evaporation system. The organic liquid evaporation system comprises a housing having at least one inlet and at least one outlet. At least a first evaporator plate radially extending from a sidewall of the housing, and at least a second evaporator plate radially extending from a sidewall of the housing define a serpentine flow path within the housing. A heating source is in thermal communication with the first evaporator plate and the second evaporator plate, wherein the heating source provides heat to the first and second evaporator plates to evaporate organic liquid introduced within the inlet to produce a vapor through the outlet. A method for preparing powder pre-forms and oxide soot using the organic liquid evaporation system is also disclosed.

### BRIEF DESCRIPTION OF THE DRAWINGS

Referring now to the figures wherein like elements are numbered alike:

FIG. 1 is a schematic view illustrating one embodiment of an organic liquid evaporation system showing its various constituents;

FIG. 2 is a schematic view illustrating one embodiment of the invention for introducing organic liquid into the organic liquid evaporation system;

FIG. 3 is a schematic view illustrating one embodiment of the invention for collecting and processing organic vapors produced in the organic liquid evaporation system;

FIG. 4 is a schematic view of one embodiment of evaporator plates used in the organic liquid evaporation system; and

FIG. 5 is a graphical view of the performance of an organic liquid evaporation system illustrating a sequential change in the mass fraction of organic liquid from the inlet to the outlet of the evaporation system.

### DETAILED DESCRIPTION OF THE INVENTION

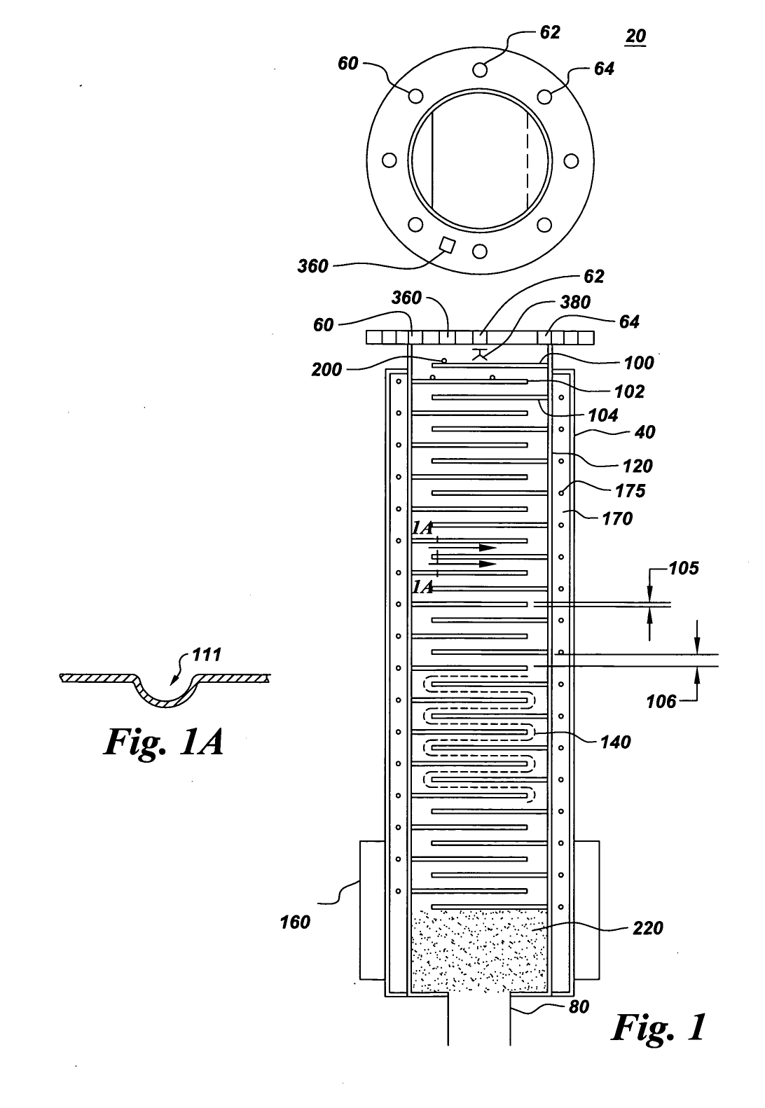

Referring to the drawings in general and to FIG. 1 in particular, it will be understood that the illustrations are for the purpose of describing a preferred embodiment of the invention and are not intended to limit the invention thereto. In the following description, like reference characters designate like or corresponding parts throughout the several views shown in the figures. It is also understood that terms such as “top,” “bottom,” “outward,” “inward,” and the like are words of convenience and are not to be construed as limiting terms. Turning to FIG. 1, a schematic representation of a cross-section of an organic liquid evaporation system is shown. Among the evaporation systems that fall within the scope of the present invention are distillers, aerosol generators, and cyclones. However, it will be appreciated by those skilled in the art that other evaporation and heating devices will fall within the scope of the invention.

An organic liquid evaporation system 20, shown in FIG. 1, comprises a housing 40 having at least one inlet 60 and at least one outlet 80. A first evaporator plate 100 extends radially from sidewall 120 of housing 40 and at least a second evaporator plate 102 (typically a plurality of second evaporator plates) extends radially from sidewall 120 of housing 40. In one embodiment of the invention, the at least one second evaporator plate 102 (and often a number of additional evaporator plates) is vertically offset from the first evaporator plate 100 such that the first evaporator plate and the at least one second evaporator plate define a serpentine flow path 140 within housing 40. A heating source 160 in thermal communication 180 with the first evaporator plate 100 and the second evaporator plate 102 is provided. Heating source 160 provides heat to the first and second evaporator plates (100, 102) to evaporate organic liquid (200) introduced within inlet (60) and produce vapor (220) through outlet (80). In all embodiments of the present invention, the internal pressure of housing 40 is maintained at a substantially constant pressure so as to dispense vapor 220 at a uniform and regulated rate under a steady state flow.

The first evaporator plate 100 and subsequent evaporator plates (102, 104) are typically heated using a heating and cooling component 170 that comprises at least one of a heating fluid jacket, an electrical heating resistance coil and combinations thereof. In some embodiments, evaporator plates 100 further comprise a concave surface 111 having a passage for organic liquid 200 to travel to subsequent evaporator plates (102, 104) along a serpentine flow path 140. The concave surface 111 in combination with the serpentine flow path 140 provides a conduit for fluid flow through evaporation system 20 thereby minimizing splashing. In some embodiments, the evaporator plates (100, 102, 104) are perforated so as to facilitate quicker fluid transport from one evaporator plate to an adjacent evaporator plate. In some embodiments, evaporator plates 100 are provided with individual temperature control 175 so as to ensure a required temperature gradient between successive evaporator plates and thus maintain a control over the process. Evaporator plates 100 comprise a high thermal conductivity material, typically a metal or ceramic, and often are selected from the group consisting of aluminum, copper, steel, chromium, nickel, iron, titanium, tantalum, gold, silver, platinum, zinc, and alloys and combinations thereof. In some embodiments, the evaporator plates 100 have a thickness 105 between about 0.5 mm to about 10 mm and the vertical spacing 106 between adjacent plates is about 10 mm to about 40 mm. Evaporator plates 100 are designed to convey organic liquid 200 from inlet 60 to outlet 80 of the housing 40. In the transition from inlet 60 to outlet 80 along evaporator plates 100, organic liquid 200 is heated to boiling via a graded increase in the temperature of the evaporator plates 100 until an organic vapor 220 is formed. Evaporator plates 100 are typically designed using a material of high thermal conductivity to facilitate efficient heat exchange between the heater 170 and the organic fluid 200 so as to enhance the rate of conversion to vapor 220.

In operation, inlet 60 is connected to one or many liquid supply cylinders 240 that supply an organic liquid 200 at a fixed predetermined pressure. Similarly, outlet 80 is connected to a burner supply line 300 that draws organic vapor 220 at a fixed predetermined pressure. Due to a fixed pressure maintained at each inlet and outlet of housing 40, the internal fluid pressure inside housing 40, is maintained substantially constant. As used herein, the term “substantially constant” means a pressure differential between the inlet 60 and the outlet 80 of less than about 5 psi and more preferably less than about 1 psi that would help maintain a relatively constant flow of vapor therethrough. Embodiments of the present invention thus provide a substantially constant internal pressure within housing 40 wherein a phase transition occurs from the liquid phase 200 to the gaseous phase 220 upon the application of heat. Because organic liquid evaporation system 20 provides a substantially constant internal pressure, a smooth, steady state service without pulsations, sputter or peristaltic vapor dispensing results.

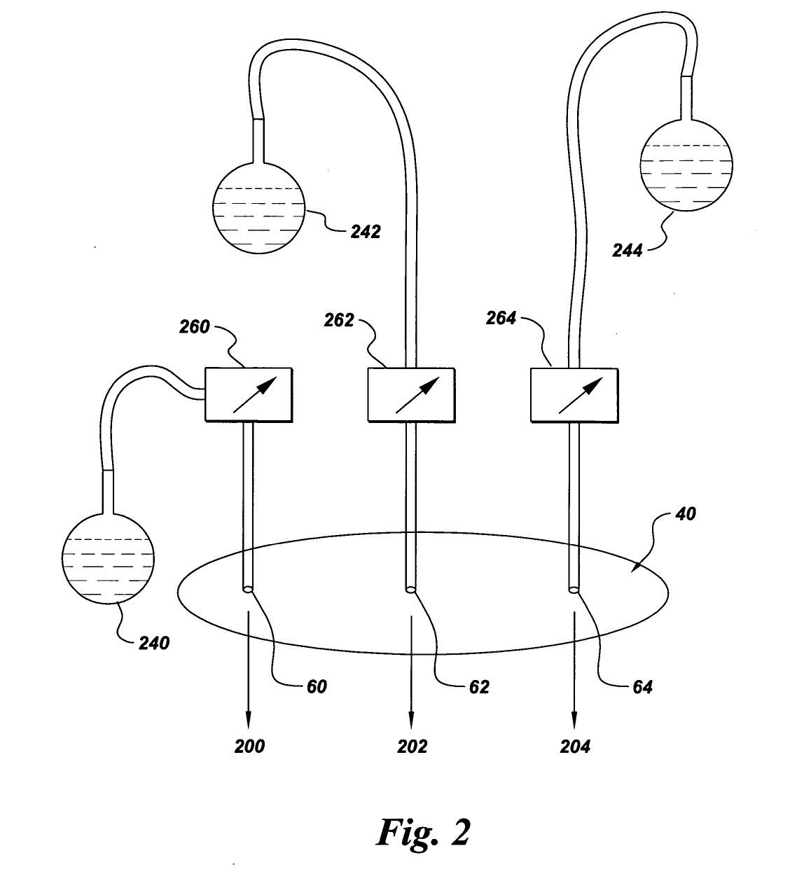

In another embodiment of the present invention, shown in FIG. 2, housing 40 has a plurality of inlets 60, 62, 64. The plurality of inlets 60, 62, 64 may convey one organic liquid 200 or may convey multiple organic liquids 200, 202, 204. Inlets 60, 62, 64 are connected to organic liquid supply cylinders 240, 242, 244 via upstream pressure regulators 260, 262, 264. In some embodiments, the upstream pressure regulators are set to the same pressure with respect to one another and in other embodiments, they are set to different pressures with respect to one another so as to achieve blending of organic vapors in different proportions as per need. Organic liquid 200 or organic liquids 200, 202, 204 typically comprise at least one aqueous and organic constituent of aluminum, silicon, germanium, titanium, zirconium, boron, magnesium, calcium and combinations, and mixtures thereof. Because of the pressure regulators, the invention can provide multiple organic liquids and also provide a variable vapor mix that would be difficult to provide using other means.

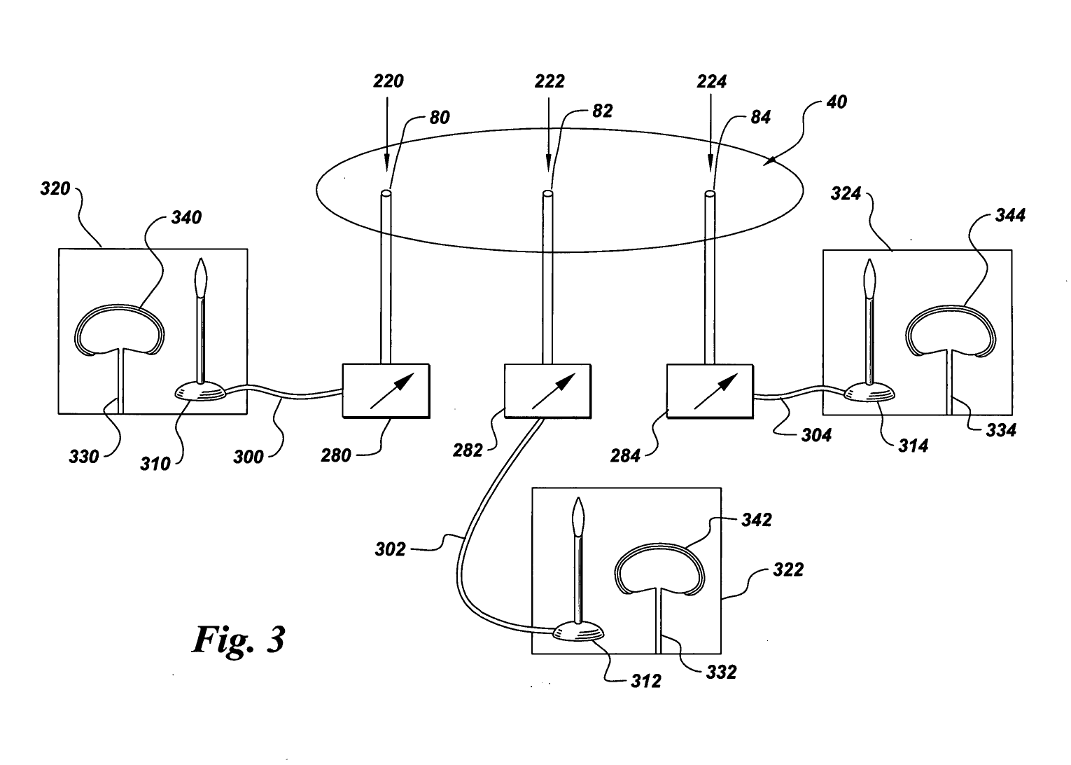

In a third embodiment of the present invention, shown in FIG. 3, the housing 40 has a plurality of outlets 80, 82, 84. The plurality of outlets 80, 82, 84 connect to burner supply lines 300, 302, 304 via downstream pressure regulators 280, 282, 284. In some embodiments, the downstream pressure regulators 280, 282, 284 are set to the same pressure with respect to one another and in other embodiments, they are set to different pressures with respect to one another to provide a blend of organic vapor in different, proportions as per need. Since the concentration (or molar concentration) of individual vapor components depends upon the partial pressure of the component, a manipulation of downstream pressure regulators 280, 282, 284 permits a manipulation of the concentration of organic vapors 220, 222, 224. Thus, the organic vapors may be mixed and blended in any desired proportion.

Organic liquid evaporation systems that do not feature a constant internal fluid pressure within housing 40 are often characterized by a jerky, sputtering, pulsating peristaltic type vapor dispensing at the plurality of outlets 80. Such discontinuous vapor dispensing may introduce an undesired heterogeneity, a stoichiometric mismatch or a molecular imbalance during blending. To minimize such effects, conventional organic liquid evaporation systems have used a carrier gas that serves as a diluent and maintains a steady state vapor flow at the outlet. The present invention does not require the provision of a carrier gas to deliver organic vapors under steady state conditions. However, the organic liquid evaporation system provided by the invention is readily amenable to a carrier gas supply input to deliver diluent conveyed organic vapors under steady state conditions. The carrier gas is usually an inert gas that does not chemically react with organic vapor 220. Typically, the carrier gas 370 includes a gas selected from the group comprising nitrogen, helium, neon, argon, krypton, argon, xenon and combinations thereof.

In a fourth embodiment of the present invention, the housing 40 further comprises a carrier gas inlet 360 (FIG. 1) for delivery of a carrier gas 370 into the housing 40. The use of carrier gas 360 is preferred and is not mandatory for the functioning of the organic liquid evaporation system 20 claimed in this invention. The uniform dispensing of vapor 220 is aided by the use of carrier gas 370 as an addition over the constant internal pressure inside housing 40 that delivers uniform and regulated dispensing of vapor 220. Vapor 220 comprises an organic vapor phase of an element selected from the group consisting of aluminum, silicon, germanium, titanium, zirconium, boron, magnesium, calcium and combinations, mixtures, composites, alloys, and functionally graded combinations-thereof.

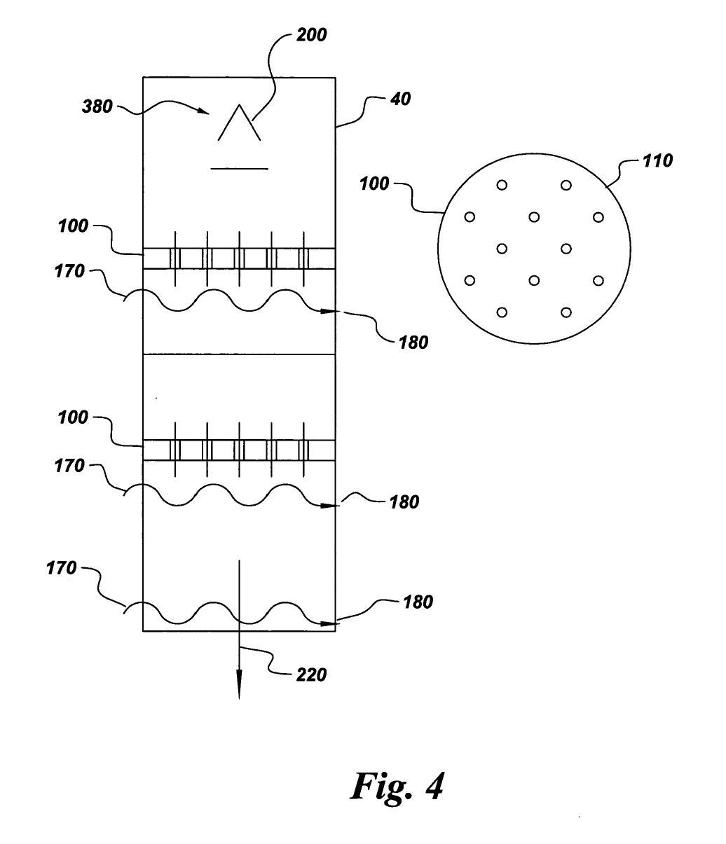

In some embodiments of the present invention, the organic liquid evaporation system 20 further comprises a droplet-generating device 380 (FIG. 4) for example, a fogger, spray nozzle, ultrasonic device and combinations thereof. The droplet-generating device 380 atomizes organic liquid 200 into fine droplets that readily convert to organic vapor 220 upon heating by evaporator plates 100, 102, 104 located inside housing 40.

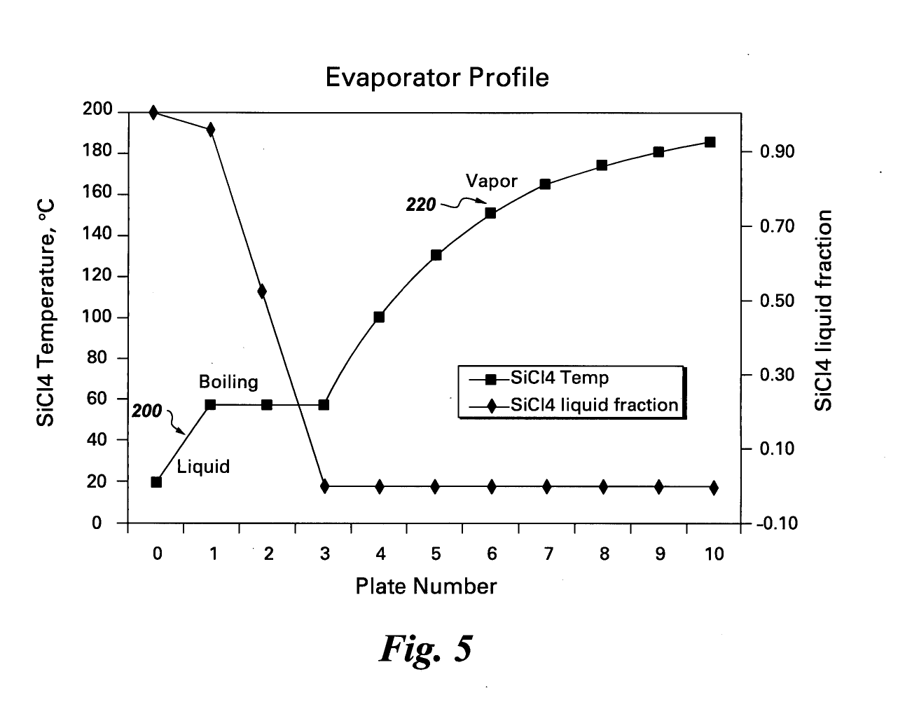

An evaporation profile using the present invention, shown in FIG. 5, illustrates the performance of an organic liquid evaporation system 20 designed to evaporate silicon tetrachloride and to produce silicon tetrachloride vapor. The organic liquid evaporation system 20 was designed with 10 evaporator plates 100 stacked in a substantially vertically oriented housing 40. The evaporation system 20 illustrated includes a cylindrical housing about 23 cm long with an inside diameter of about 6 cm, thereby making the evaporating system 20 a portable, hand-held assembly. The evaporator plates 100 were about 2.54 cm long and about 2.54 cm wide and the inside wall temperature of the housing 40 was maintained at about 200° C., designed to retain silicon tetrachloride vapor in the vapor state and free from condensate. An organic liquid 200 i.e. silicon tetrachloride, was introduced through an inlet 60 at a mass flow rate of about 30 g/minute, into the organic liquid evaporation system 20. It was determined that heat transfer coefficients in the organic liquid evaporation system 20 were about 113.5 W/m²C from the evaporator plates 100 to the organic liquid, about 1135 W/m²C from the evaporator plates 100 to the organic liquid 200 when it boils and about 28.4 W/m²C from the side walls 120 of the housing 40 to the organic vapors produced. In the organic liquid evaporation system 20, the organic liquid 200 is heated to its boiling point in the first plate, it boils to completion at about the third plate and the vapor is superheated to about 180° C. in the remaining fourth to the tenth evaporator plates. Correspondingly, the mass fraction of silicon tetrachloride remaining as liquid reduces from 1.0 at the inlet to zero at the third plate 104 where boiling and consequent conversion to silicon tetrachloride vapor 220 is completed. Silicon tetrachloride vapors 220 leave the organic liquid evaporation system 20 via at least one outlet 80 located downstream of the final evaporator plate.

The organic vapor produced 220 is a precursor that can be used to make among other materials, high performance ceramics, optical materials and functionally graded materials i.e. materials that have a gradient in their physical, chemical, mechanical, electronic or structural properties across their thickness direction. Functionally graded optical materials, in particular, have applications in photonics and can be made using the method 400 of the present invention as described below.

Vapors 220 are fed to burners 310 via burner supply lines 300 and downstream pressure regulators 280 (FIG. 3). Burners 310 are placed within deposition chambers 320 so as to aid consolidation of material. Deposition chambers 320 may be evacuated or non-evacuated and pressurized or non-pressurized. Vapors 220 are ignited to deposit inorganic soot on mandrels 330 placed inside the deposition chambers 320. Since the inorganic soot is produced from a vapor phase reaction, it is usually in finely dispersed forms and deposits on mandrels 330 as mandrel cake 340. The mandrel cake comprises at least one inorganic oxide selected from the group consisting of glass, alumina, silica, germania, titania, zirconia, boria, magnesia, calcia, chromia, their substituents, combinations, mixtures, stoichiometric modifications, composites, alloys and functionally graded combinations thereof. In one embodiment of the present invention, a monitoring and adjustment of downstream pressure regulators 280, 282, 284 and burners 310, 312, 314 yields a mandrel cake having a structured heterogeneity, i.e. a mandrel cake having a gradient in chemical composition across one of its dimensions, hereinafter referred to as a functionally graded material.

Mandrel cakes 340 are collected from deposition chambers 320 and subjected to a processing that comprises at least one of compaction, heat treatment, sintering, densification, and combinations thereof. The mandrel cake processing may be either collective in which individual mandrel cakes are mixed and blended or separate in which mandrel cakes are processed independently. Mandrel cake processing usually yields a material comprising at least one of a homogeneous material, a heterogeneous material, an isotropic material, an anisotropic material, a functionally graded material, a microstructured material, and combinations thereof. In some embodiments, the mandrel cake processing yields a material comprising at least one of an optical mirror, an opaque material, a translucent material, a transparent material, material with graded optical properties, and combinations thereof. In some embodiments of the present invention, the material with graded optical properties further comprises a material with graded refractive index. In yet other embodiments of the present invention, the material with graded refractive index further comprises a material having a refractive index between the values of about 1.00 and about 2.42 and has applications in photonics and in optical waveguides.

In one embodiment of the present invention, housing 40 is substantially vertically oriented. In another embodiment, the evaporator plates 100, 102, 104 are substantially horizontally oriented and extend radially from a sidewall of the housing with the second evaporator plate vertically offset from the first evaporator plate so as to permit a continuous serpentine flow path. In a third embodiment, evaporator plates are perforated evaporator plates circumferentially disposed within housing 40 as shown in FIG. 4. In a fourth embodiment, evaporator plates are substantially horizontally oriented perforated evaporator plates circumferentially disposed within housing 40. In a fifth embodiment of the present invention, a method for making organic vapor 220 is provided. In a sixth embodiment, a portable and hand-held organic liquid evaporation service, suitable for field work and outdoor application is provided.

While typical embodiments have been set forth for the purpose of illustration, the foregoing description should not be deemed to be a limitation on the scope of the invention. Accordingly, various modifications, adaptations, and alternatives may occur to one skilled in the art without departing from the spirit and scope of the present invention.

1. An organic liquid evaporation system comprising:
a) a housing having at least one inlet and at least one outlet;
b) at least a first evaporator plate radially extending from a sidewall of said housing;
c) at least a second evaporator plate radially extending from said sidewall of said housing, wherein said housing, said first evaporator plate and said second evaporator plate define a serpentine flow path within said housing; and
d) a heating source in thermal communication with said first evaporator plate and said second evaporator plate, wherein said heating source provides heat to said first and second evaporator plates to evaporate organic liquid introduced within said inlet to produce a vapor through said outlet.

2. The organic liquid evaporation system according to claim 1, wherein said at least a first evaporator plate and at least a second evaporator-plate are heated using a heating and cooling component comprising at least one of a heating fluid jacket, an electrical heating resistance coil and combinations thereof.

3. The organic liquid evaporation system according to claim 1, wherein said housing has a plurality of inlets.

4. The organic liquid evaporation system according to claim 3, wherein said plurality of inlets are connected to organic liquid supply cylinders via upstream pressure regulators.

5. The organic liquid evaporation system according to claim 1, wherein said housing has a plurality of outlets.

6. The organic liquid evaporation system according to claim 5, wherein said plurality of outlets connect to a burner supply line via downstream pressure regulators.

7. The organic liquid evaporation system according to claim 1, wherein the internal pressure of said housing is maintained at constant pressure.

8. The organic liquid evaporation system according to claim 1, wherein said housing further comprises a carrier gas inlet for delivery of a carrier gas into said housing.

9. The organic liquid evaporation system according to claim 1, wherein said organic liquid evaporation system further comprises a droplet generating device including a fogger, spray nozzle, ultrasonic device and combinations thereof.

10. An organic liquid evaporation system comprising:
a) a substantially vertical oriented housing having at least one inlet and at least one outlet;
b) at least a first substantially horizontally oriented evaporator plate radially extending from a sidewall of said housing;
c) at least a second substantially horizontally oriented evaporator plate radially extending from said sidewall of said housing and vertically offset from said first evaporator plate, wherein said housing, said first evaporator plate and said second evaporator plate define a serpentine flow path within said housing; and
d) a heating source in thermal communication with said first evaporator plate and said second evaporator plate, wherein said heating source provides heat to said first and second evaporator plates to evaporate organic liquid introduced within said inlet to produce a vapor through said outlet.

11. The organic liquid evaporation system according to claim 10, wherein said at least a first substantially horizontally oriented evaporator plate and at least a second substantially horizontally oriented evaporator plate are heated using a heating and cooling component comprising at least one of a heating fluid jacket, an electrical heating resistance coil and combinations thereof.

12. The organic liquid evaporation system according to claim 10, wherein said housing has a plurality of inlets.

13. The organic liquid evaporation system according to claim 12, wherein said plurality of inlets are connected to organic liquid supply cylinders via upstream pressure regulators.

14. The organic liquid evaporation system according to claim 10, wherein said housing has a plurality of outlets.

15. The organic liquid evaporation system according to claim 14, wherein said plurality of outlets connect to a burner supply line via downstream pressure regulators.

16. The organic liquid evaporation system according to claim 10, wherein the internal pressure of said housing is maintained at constant pressure.

17. The organic liquid evaporation system according to claim 10, wherein said housing further comprises a carrier gas inlet for delivery of a carrier gas into said housing.

18. The organic liquid evaporation system according to claim 10, wherein said organic liquid evaporation system further comprises a droplet generating device including a fogger, spray nozzle, ultrasonic device and combinations thereof.

19. An organic liquid evaporation system comprising:
a) a housing having at least one inlet and at least one outlet;
b) at least a first perforated evaporator plate circumferentially disposed within said housing;
c) at least a second perforated evaporator plate circumferentially disposed within said housing;
d) an atomizer for atomizing organic liquid introduced within said inlet into droplets; and
e) a heating source in thermal communication with said first perforated evaporator plate and said second perforated evaporator plate, wherein said heating source provides heat to said first and second perforated evaporator plates to evaporate introduced droplets through said perforated plates to produce a vapor through said outlet.

20. The organic liquid evaporation system according to claim 19, wherein said at least a first perforated evaporator plate and at least a second perforated evaporator plate are heated using a heating and cooling component comprising at least one of a heating fluid jacket, an electrical heating resistance coil and combinations thereof.

21. The organic liquid evaporation system according to claim 19, wherein said housing has a plurality of inlets.

22. The organic liquid evaporation system according to claim 21, wherein said plurality of inlets are connected to organic liquid supply cylinders via upstream pressure regulators.

23. The organic liquid evaporation system according to claim 19, wherein said housing has a plurality of outlets.

24. The organic liquid evaporation system according to claim 23, wherein said plurality of outlets connect to a burner supply line via downstream pressure regulators.

25. The organic liquid evaporation system according to claim 19, wherein the internal pressure of said housing is maintained at constant pressure.

26. The organic liquid evaporation system according to claim 19, wherein said housing further comprises a carrier gas inlet for delivery of a carrier gas into said housing.

27. The organic liquid evaporation system according to claim 19, wherein said atomizer further comprises a droplet generating device including a fogger, spray nozzle, ultrasonic device and combinations thereof.

28. An organic liquid evaporation system comprising:
a) a substantially vertical oriented housing having at least one inlet and at least one outlet;
b) at least a first substantially horizontally oriented perforated evaporator plate circumferentially disposed within said housing;
c) at least a second substantially horizontally oriented perforated evaporator plate circumferentially disposed within said housing;
d) an atomizer for atomizing organic liquid introduced within said inlet into droplets; and
e) a heating source in thermal communication with said first perforated evaporator plate and said second perforated evaporator plate, wherein said heating source provides heat to said first and second perforated evaporator plates to evaporate introduced droplets through said perforated plates to produce a vapor through said outlet.

29. The organic liquid evaporation system according to claim 28, wherein said at least a first substantially horizontally oriented perforated evaporator plate and at least a second substantially horizontally oriented perforated evaporator plate are heated using a heating and cooling component comprising at least one of a heating fluid jacket, an electrical heating resistance coil and combinations thereof.

30. The organic liquid evaporation system according to claim 28, wherein said housing has a plurality of inlets.

31. The organic liquid evaporation system according to claim 30, wherein said plurality of inlets are connected to organic liquid supply cylinders via upstream pressure regulators.

32. The organic liquid evaporation system according to claim 28, wherein said housing has a plurality of outlets.

33. The organic liquid evaporation system according to claim 32, wherein said plurality of outlets connect to a burner supply line via downstream pressure regulators.

34. The organic liquid evaporation system according to claim 28, wherein the internal pressure of said housing is maintained at constant pressure.

35. The organic liquid evaporation system according to claim 28, wherein said housing further comprises a carrier gas inlet for delivery of a carrier gas into said housing.

36. The organic liquid evaporation system according to claim 28, wherein said atomizer further comprises a droplet generating device including a fogger, spray nozzle, ultrasonic device and combinations thereof.

37. A method for making organic vapor comprising the steps of:
a) providing a housing having at least one inlet and at least one outlet;
b) providing at least a first evaporator plate radially extending from a sidewall of said housing;
c) providing at least a second evaporator plate radially extending from a sidewall of said housing, wherein said housing, said first evaporator plate and said second evaporator plate define a serpentine flow path within said housing;
d) introducing at least one organic liquid through said at least one inlet; and
e) providing a heating source in thermal communication with said first evaporator plate and said second evaporator plate, wherein said heating source provides heat to said first and second evaporator plates to evaporate said organic liquid introduced within said inlet to provide a vapor through said outlet.

38. The method according to claim 37, wherein said at least a first evaporator plate and at least a second evaporator plate are heated using a heating and cooling component comprising at least one of a heating fluid jacket, an electrical heating resistance coil and combinations thereof.

39. The method according to claim 37, wherein said housing has a plurality of inlets.

40. The method according to claim 39, wherein said plurality of inlets are connected to organic liquid supply cylinders via upstream pressure regulators.

41. The method according to claim 37, wherein said housing has a plurality of outlets.

42. The method according to claim 41, wherein said plurality of outlets connect to a burner supply line via downstream pressure regulators.

43. The method according to claim 37, wherein the internal pressure of said housing is maintained at constant pressure.

44. The method according to claim 37, wherein said housing further comprises a carrier gas inlet for delivery of a carrier gas into said housing.

45. The method according to claim 37, wherein said organic liquid is introduced from said at least one inlet to at least one atomizer for atomizing said organic liquid into droplets.

46. The method according to claim 45 wherein said at least one atomizer further comprises a droplet generating device including a fogger, spray nozzle, ultrasonic device and combinations thereof.

47. The method according to claim 37, wherein said vapor is fed to a burner and ignited to deposit inorganic soot on a mandrel as mandrel cake.

48. The method according to claim 47, wherein said inorganic soot comprises at least one inorganic oxide selected from the group consisting of glass, alumina, silica, germania, titania, zirconia, boria, magnesia, calcia, chromia, their substituents, combinations, mixtures, stoichiometric modifications, composites, alloys and functionally graded combinations thereof.

49. The method according to claim 47, wherein said mandrel cake is subjected to a processing that comprises at least one of compaction, heat treatment, sintering, densification, and combinations thereof.

50. The method according to claim 49, wherein said processing yields a material comprising at least one of an optical mirror, an opaque material, a translucent material, a transparent material, material with graded optical properties, and combinations thereof.

51. The method according to claim 50, wherein said material with graded optical properties further comprises a material with graded refractive index.
